(19) United States
(12) Patent Application Publication
(10) Pub. No.: US 2010/0266930 A1
(43) Pub. Date: Oct. 21, 2010

(54) POWDER FOR ELECTROLYTE IN FUEL CELLS

(76) Inventor: Hilmar Vidarsson, Munka Ljungby (SE)

Correspondence Address: BUCHANAN, INGERSOLL & ROONEY PC, POST OFFICE BOX 1404, ALEXANDRIA, VA, 22313-1404, US

(21) Appl. No.: 12/746,962

(22) PCT Filed: Dec. 9, 2008
(86) PCT No.: PCT/EP08/67071

§ 371 Date: Jun. 29, 2010

Related U.S. Application Data
(60) Provisional application No. 61/006,184, filed on Dec. 28, 2007.

(30) Foreign Application Priority Data
Dec. 10, 2007 (DK) PA 2007 01763

(51) Int. Cl. H01M 8/10

(52) U.S. Cl. 429/495

(57) ABSTRACT

An agglomerated powder is formed comprising a metal oxide agglomerated with at least one alkaline carbonate to be used as an electrolyte in fuel cells. The obtained agglomerates exhibit good flow properties which facilitates the handling of the powder and improved homogeneity and stability compared to a plain mixture of the ingredients. In a preferred embodiment the technology is directed to agglomerating fine and irregular particulate ceria powder with lithium and sodium or potassium carbonates to be used for compaction of thin plates used as electrolytes for solid oxide fuel cells. A powder to be used as electrolyte in fuel cells, comprising a metal oxide and at least one alkali carbonate is provided. A bonding is formed between the metal oxide and the at least one alkali carbonate during mixing thereby providing an agglomerated powder and avoiding segregation.

### FIELD OF THE INVENTION

The present invention concerns an agglomerated powder comprising a metal oxide agglomerated with at least one alkaline carbonate to be used as an electrolyte in fuel cells. The obtained agglomerates exhibit good flow properties which facilitates the handling of the powder and improved homogeneity and stability compared to a plain mixture of the ingredients. The invention also concerns a method for agglomerating oxide powders with alkaline carbonates. Especially, the present invention is directed to agglomerating fine and irregular particulate ceria powder with lithium and sodium or potassium carbonates to be used for compaction of thin plates used as electrolytes for solid oxide fuel cells.

### BACKGROUND OF THE INVENTION

In the recent years numerous of publications and patent dealing with development of fuel cells have been published due to the rising interest of alternative energy sources.

U.S. Pat. No. 4,317,865 (Trocciola) describes a molten carbonate fuel cell electrolyte-matrix material and a molten carbonate fuel cell including such material. Example of matrix material is ceria, described in this context as CeO₂ but also as reduced forms such as Ce₂O₃ or CeO₂₋ₓ wherein x can vary between 0 and 0.5. The ceria material could be of high purity but the material may also include impurities such as rare earth oxides. The molten electrolyte material consisting essentially of alkali metal carbonates such as lithium carbonate, sodium carbonate, potassium carbonates or mixtures thereof. According to the publication, the invented molten carbonate fuel cell electrolyte-matrix material shows a high degree of stability despite the aggressive environment cased by the molten carbonates.

In an article by Zhou, published in International Journal of Energy Research, 2006, 30:895-903 a new generation of solid oxide fuel cells (SOFC) is described, working on low temperatures, 300-600° C. These low temperature solid oxide fuel cells can be directly operated by for example coal, syngas and liquid hydrocarbon fuels such as methanol and ethanol. The solid electrolyte in these fuel cells may also be based on ceria.

In U.S. Pat. No. 6,991,867 to Zhou, a fuel cell comprising a fuel chamber, an anode, a cathode an electrolyte disposed between said anode and said cathode and an oxidant chamber is described. The fuel chamber and oxidant chamber enclose the anode, the cathode, and electrolyte. A fuel, flowing from the fuel chamber is oxidized at the anode, thereby producing energy. The electrolyte being a ceramic composite comprising at least one salt and at least one oxide. Examples are given of various composite oxides and salts containing carbonate ions, chloride ions or fluoride ions. According to one embodiment the oxide comprises a ceria based composite oxide and the fuel cell is operating at intermediate temperatures, 300-800° C.

US application 2002/0135095 discuss the production of thin plates of metals or ceramic materials. The problem addressed is how to manufacture very thin plates of metals or ceramics whereof at least one side is highly patterned. Such thin plates are used in production of for example plate heat exchangers and fuel cells.

The patent application states that:
According to the invention a moulding technique is used, employing high kinetic energy for the manufacturing of the plate with high relief patterned sides. It is however not possible to manufacture such plates by high kinetic energy forming by a single stroke when starting from a powder. Even if the material is softened by the very high pressure that is generated, the ability of the material will nevertheless be too restricted to flow not only in the labyrinth-like passages in the part of the moulding tool that shall form the high relief patter, but also to flow out to the thicker edge portions. Nor it is possible in the same tool to form the product by repeating strokes. To the contrary, the problem would be accentuated. This is particularly true when starting from a powder, which certainly can be plasticized in a surface layer at the first impact. But that would instead make the plasticizing of the powder further down in the powder bed more difficult, resulting in a very inhomogeneous compacting and increased friction. The principal of the invention, supposed to solve the problem, is to first manufacture an intermediate product suitable for a final forming operation based on forming a high relief patterned plate in a single stroke through the supply of very high kinetic energy.

Nothing in the above mentioned patent application however mention the physical properties of the powder, such as homogeneity, resistance against segregation, stability in powder apparent density and flow. These properties are well known to be of great importance in order to fill a die cavity evenly and with high speed. These properties will have a significant impact for the ability of producing compacted bodies having a minimum of variation of composition and density within a produced part, weight scattered between the produced parts and also on the ability of producing compacted parts at a high production rate. The importance of good powder properties is specially accentuated when filling compaction dies of difficult shapes, such as those mentioned in the application above.

### PROBLEM TO BE SOLVED

Oxide powders of small particle size and with extremely irregular shapes, e.g. Cerium oxide, ceria, have very poor powder properties. It is thus difficult to handle these powders when production of sub-millimetre thick, solid sheets of solid electrolytes through pressurised consolidation is required. When the presence of alkaline carbonates is required in these powders, it is furthermore difficult to achieve the desired homogeneity of the mix when these are blended in a particulate form.

The present invention provides agglomerates of extremely irregular metal oxides and alkali carbonates having improved powder properties enabling an economical production and improved quality of produced thin plates by various compaction methods. Further, the present invention also provides a method directed to the manufacture of agglomerates of metal oxide, such as ceria, and alkali metal carbonates for the manufacture of thin plates used as electrolytes in fuel cells. Especially, the present invention also provides a method of providing agglomerates of fine metal oxides and a homogenous compound carbonate of lithium and at least one other alkali metal carbonate, as well as the agglomerates obtained by the method of the present invention.

The increased homogeneity of the mix also causes a more efficient utilization of the carbonates which are present in the mix. This means that it is not necessary to add a surplus of carbonates.

### OBJECTS OF THE INVENTION

To provide an agglomerate containing a fine and/or irregular particulate metal oxide and at least one alkali carbonate, preferably combined with other alkali carbonates, typically a cerium oxide agglomerated with lithium carbonate combined with other alkali carbonates showing a low tendency of segregation between the constituents and having improved homogeneity, stability, and powder properties such as powder apparent density and flow.

To provide a method for preparation of agglomerates containing a fine and/or irregular particulate metal oxide and lithium carbonate combined with other alkali carbonates, typically a metal oxide agglomerated with lithium carbonate combined with other alkali carbonates.

### DETAILED DESCRIPTION OF THE INVENTION

The present invention provides an agglomerate and a method for producing the agglomerate, comprising a metal oxide powder, especially CeO₂, ceria, with a carbonate, preferably containing lithium and at least one other alkali metal carbonate. The obtained agglomerates show improved homogeneity, stability and powder properties such as apparent density, AD, and flow.

The metal oxide powder, i.e. the ceria powder could be of any particle size; however ceria used for preparation of solid electrolytes in solid oxide fuel cells normally has a particle size being about 50 μm or less.

It has been found that the precursor for the lithium material preferably is lithium in form of hydroxide although lithium carbonate may be used. Any particle size of the lithium hydroxide may be used; the purity should be such that it is compatible with the functionality of the intended use. By using lithium hydroxide, material of far more solubility in aqueous solution is obtained compared to when using lithium carbonate.

The precursor for the other alkali metals, preferably sodium or potassium, should preferably be in the form of hydrogen carbonates, however in certain embodiments sodium or potassium carbonates may work. There is no restriction concerning the particle size and purity as long as it is compatible with the intended use. When using a lithium hydroxide the used alkali metal shall preferably be in the form of hydrogen carbonate.

In the preferred embodiment the lithium hydroxide and the sodium or potassium hydrogen carbonate are dissolved in cold or warm water. There are no special requirements of added amounts of materials to water; however added amounts up to saturation concentration have been found to work well.

In one embodiment the lithium hydroxide and the alkali metal hydrogen carbonate are dissolved in the same water solution.

In the next step the obtained solutions are added to the metal oxide powder, either as one premixed solution or one solution after the other.

When the different solutions are mixed prior to the agglomeration step, a reaction occurs yielding a combined lithium and sodium carbonate, in the case the alkali metal is sodium, according to below;

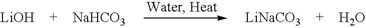

The mixture of the solutions and the metal oxide powder is then subjected to any known method of agglomeration such as spray drying or fluidized bed drying, or techniques involving tumbling/growth of the material, e.g. rotating drum evaporation.

Depending of the intended use of the agglomerates, the obtained dried material may be further processed by e.g. crushing and/or sieving to a desired particle size.

### Example 1

CeO₂ powder was agglomerated with 20% by weight of a mixture (1:1 molar) of Li₂CO₃/Na₂CO₃ in an 8% water solution. The agglomeration was conducted by drying the mixture at 130° C. combined with mechanical agitation. The obtained cake was gently crushed and sieved through a 500 micron sieve.

Table 1 below, shows however in contrast with Na₂CO₃ and K₂CO₃ that the solubility of Li₂CO₃ in both cold and hot water is very limited.

TABLE 1

| | Solubility Cold Water | Solubility Hot Water |
|---|---|---|
| Material | (g/100 ml) | (g/100 ml) |
| Li₂CO₃ | 1.54 (0° C.) | 0.72 (100° C.) |
| Na₂CO₃ | 7.1 (0° C.) | 45.5 (100° C.) |
| K₂CO₃ | 112 (20° C.) | 156 (100° C.) |

In fact, this low solubility of Li₂CO₃ in water makes its use rather impractical for a straightforward agglomeration process when a high content of lithium is required. This was verified in that the resulting agglomerates in this example contained undissolved particles of Li₂CO₃. A different approach was thus attempted, which will now be described below.

### Example 2

In this example, agglomerates were produced according to the same procedure as described above. However, in order to form the desired final composition of LiNaCO₃, alternative ingredients were chosen for further processing, according to the reaction formula:

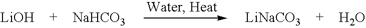

Both ingredients are easily soluble in water, as can be seen in Table 2 below i.e. the solubility of each alkali carbonate or of each component forming an alkali carbonate should preferably be at least 5 g/100 ml in water at 60° C. in order to work effectively.

TABLE 2

| | Solubility Cold Water | Solubility Hot Water |
|---|---|---|
| Material | (g/100 ml) | (g/100 ml) |
| NaHCO₃ | 6.9 (0° C.) | 16.4 (60° C.) |
| LiOH•H₂O | 22.3 (10° C.) | 26.8 (80° C.) |

Two different approaches were tested:

A. Making two different solutions, one containing LiOH.H₂O (150 g/l) and one containing NaHCO₃ (100 g/l), mixing these in sequence with the CeO₂ powder, before subjecting them to the drying and crushing treatment described previously.
B. Dissolving and mixing the LiOH.H₂O and NaHCO₃, in the same amounts as in A, in the same solution before the above described agglomeration procedure.

Both procedures gave similar results in terms of agglomerate formation.

In comparison with the untreated CeO₂ powder, which exhibits very poor powder properties and excessive caking, the powder behaviour of the agglomerated powders from example 1 and especially from example 2 exhibited substantial improvement in terms flow and stability.

1-6. (canceled)

7. A method for producing an agglomerate powder to be used as electrolyte in fuel cells comprising at least one metal oxide and at least one alkali metal carbonate which method comprises:
a) providing a particulate metal oxide and a solution of at least one alkali metal carbonate, alkali metal hydrogen carbonate, alkali metal hydroxide, non-metal carbonate and non-metal hydrogen carbonate,
b) mixing the particulate metal oxide with the solution, and
c) providing agglomerates through evaporation of the solvent.

8. The method according to claim 7, wherein the solvent is water.

9. The method according to claim 7, wherein the at least one alkali metal carbonate comprises lithium.

10. The method according to claim 7, wherein the at least one metal oxide comprises cerium.

11. The method according to claim 7, wherein the alkali metal hydrogen carbonate is sodium hydrogen carbonate or potassium hydrogen carbonate and the non-metal hydrogen carbonate is ammonium carbonate.

12. The method according to claim 7, wherein the non-metal carbonate is ammonium carbonate.

13. The method according to claim 7, wherein the alkali hydroxide is lithium hydroxide.

14. The method according to claim 8, wherein alkali metal carbonate or of each component forming an alkali carbonate is at least 5 g/100 ml in water at 60° C.

15. The method according to claim 14, wherein the alkali carbonate contains combined carbonate of lithium and sodium and/or potassium carbonate.

16. The method according to claim 8, wherein the at least one alkali metal carbonate comprises lithium.

17. The method according to claim 8, wherein the at least one metal oxide comprises cerium.

18. The method according to claim 9, wherein the at least one metal oxide comprises cerium.

19. The method according to claim 8, wherein the alkali metal hydrogen carbonate is sodium hydrogen carbonate or potassium hydrogen carbonate and the non-metal hydrogen carbonate is ammonium carbonate.

20. The method according to claim 9, wherein the alkali metal hydrogen carbonate is sodium hydrogen carbonate or potassium hydrogen carbonate and the non-metal hydrogen carbonate is ammonium carbonate.

21. The method according to claim 10, wherein the alkali metal hydrogen carbonate is sodium hydrogen carbonate or potassium hydrogen carbonate and the non-metal hydrogen carbonate is ammonium carbonate.

22. The method according to claim 8, wherein the non-metal carbonate is ammonium carbonate.

23. The method according to claim 8, wherein the alkali hydroxide is lithium hydroxide.

24. An agglomerated powder obtained by the method of claim 1.

25. A compacted body formed by the compaction of an agglomerated powder obtained by the method of claim 1.

26. A solid electrolyte in the form of a sheet formed by the compaction of an agglomerated powder obtained by the method of claim 1.
